(19) United States
(12) Patent Application Publication
(10) Pub. No.: US 2011/0253897 A1
(43) Pub. Date: Oct. 20, 2011

(54) TERAHERTZ AND MILLIMETER-WAVE WHISPERING GALLERY MODE RESONATOR SYSTEMS, APPARATUS AND METHODS

(75) Inventors: Daryoosh Saeedkia, Waterloo (CA); Suren Gigoyan, Ashtarak (AM); Mohammad Neshat, Waterloo (CA); Safieddin Safavinaeini, Waterloo (CA)

(73) Assignee: T-RAY SCIENCE INC., Waterloo, ON (CA)

(21) Appl. No.: 13/129,232

(22) PCT Filed: Aug. 12, 2009
(86) PCT No.: PCT/CA09/01128

§ 371 Date: May 13, 2011

Related U.S. Application Data
(60) Provisional application No. 61/088,411, filed on Aug. 13, 2008.

(51) Int. Cl. G01N 21/17; G02B 6/26; G01J 1/42

(52) U.S. Cl. 250/358.1; 250/395; 385/28

(57) ABSTRACT

A sensor system includes a source of input radiation having a frequency range between about 30 GHz and 3 THz, a whispering gallery mode resonator module coupled to the source for receiving the input radiation, and a detector coupled to the whispering gallery mode resonator module. The whispering gallery mode resonator module is configured to support at least one whispering gallery mode for the input radiation, and output a transmission response having a resonance characteristic related to the at least one whispering gallery mode. The detector detects the transmission response.

### FIELD

The embodiments herein relate to sensor systems, apparatus and methods for analysis of samples, and in particular, to biosensors for classification, quantification, monitoring, and sensing of health care products, biologics, drug tablets, and tissue samples using terahertz and millimeter-wave whispering gallery mode resonators.

### BACKGROUND

Optical sensors (e.g. sensors operating in a visible spectrum) having whispering gallery mode (WGMₙₘₗ) resonators have been used for sensing and analyzing chemicals and other samples. Generally, subscripts n, m and/are used to refer to mode indices where: n is the azimuthal mode number representing the number of field maxima in the azimuthal direction; m is the radial mode number; and l is the axial mode number.

While known optical sensors are highly sensitive and selective, their fabrication, sample preparation, and tests are sophisticated and expensive.

For example, U.S. Pat. No. 6,490,039 (Maleki et al.) describes optical sensing techniques and devices based on whispering-gallery-mode micro resonators or cavities. An optical probe beam is evanescently coupled into at least one whispering gallery mode of such a resonator. A sample material to be measured may be filled within the resonator or surrounded outside the resonator to interact with and modify the whispering gallery mode or geometry of the resonator. The evanescent field outside the resonator is detected or measured to detect a change caused by the modification. This change is then processed to extract information about the sample material. This change may be reflected as, e.g., a temporal change in the mode structure during a transient period, attenuation in the evanescent field, a frequency shift in the whispering gallery mode and its evanescent field, or a change in efficiency of the evanescent coupling of the probe beam into the resonator or coupling of the energy in the whispering gallery mode out of the resonator.

U.S. Pat. No. 7,283,707 (Maleki et al.) describes a system including an optical resonator and an optical element having a periodic structure for coupling of light into the optical resonator. Maleki et al. also describes a method for coupling light.

### SUMMARY

According to one aspect of the invention, there is provided a sensor system including a whispering gallery mode resonator module, a source for providing terahertz and/or millimeter-wave input radiation to the whispering gallery mode resonator module, a detector for detecting the output terahertz and/or millimeter-wave radiation from the whispering gallery mode resonator module, and a controller for receiving user input, adjusting the source, and processing the detected output terahertz and/or millimeter-wave radiation.

The whispering gallery mode resonator module may include a dielectric resonator configured to support the whispering gallery modes of terahertz and/or millimeter-wave electromagnetic waves, a dielectric waveguide optimized for evanescently coupling terahertz and/or millimeter-wave electromagnetic radiation into and out of the dielectric resonator, an input coupler for coupling terahertz and/or millimeter-wave input radiation from the source to the dielectric waveguide, and an output coupler for coupling the output terahertz and/or millimeter-wave radiation from the dielectric waveguide to the detector.

The whispering gallery mode resonator module may include a support plate on which the dielectric waveguide and the dielectric resonator are placed. The distance L_{R} between the dielectric waveguide and the dielectric resonator/sample may be adjusted accordingly to provide critical coupling condition for sensing the sample with high sensitivity.

In some embodiments, the dielectric resonator may comprise a disk made of high-resistive silicon, and having a surface shaped to receive the sample. In some other embodiments, the dielectric resonator may comprise a sample that is shaped to act as a resonator.

According to another aspect of the invention, there is provided a whispering gallery mode resonator module including an input coupler configured to receive input radiation having a frequency of between about 30 GHz and 3 THz, a dielectric waveguide having an input end coupled to the input coupler for receiving the input radiation and an output end opposite the input end, a dielectric resonator positioned between the input end and the output end of the dielectric waveguide and offset from the dielectric waveguide, and an output coupler coupled to the output end of the dielectric waveguide. The dielectric waveguide is sized and shaped to propagate the input radiation from the input end to the output end. The dielectric resonator is sized, shaped and positioned so as to cooperate with the dielectric waveguide to support at least one whispering gallery mode for the input radiation. The output coupler is configured to output a transmission response having a resonance characteristic related to the at least one whispering gallery mode.

In some embodiments, the waveguide may be optimized for evanescently coupling the input radiation into the dielectric resonator.

In some embodiments, the dielectric resonator may include a disk made of high-resistive silicon and having a surface shaped to receive a sample thereon.

In some embodiments the whispering gallery mode resonator module may include a support plate on which the dielectric waveguide and the dielectric resonator are placed.

In some embodiments, the dielectric waveguide and the dielectric resonator may be offset by an offset distance. The offset distance may be adjusted to provide a critical coupling condition for the input radiation. The offset distance may be between about 0.05 and 3 millimeters.

In some embodiments, the input radiation may have a frequency of between about 500 GHz and 3 THz.

In some embodiments, the dielectric resonator may be a sample that is shaped to act as a resonator. For example, the sample may be a pharmaceutical tablet.

In some embodiments, the dielectric resonator may be configured to support at least five modes for the input radiation.

In some embodiments, the dielectric resonator may include a disk having a radius between about 1 and 20 millimeters.

In some embodiments, the dielectric resonator may include a ring having a central aperture and the whispering gallery mode resonator module may further include a container and a valve. The container may have a reservoir portion for receiving a liquid sample, a pipe portion, and an outlet. The pipe portion extends from the reservoir portion through the center of the dielectric resonator to the outlet. The valve is positioned between the dielectric resonator and the outlet. The valve is configured to selectively control flow of the liquid sample from the reservoir portion, through the pipe portion, and out the outlet.

In some embodiments, the dielectric resonator may include a ring having a central aperture, and the whispering gallery mode resonator module may further include a syringe. The syringe may have a reservoir portion for receiving a liquid sample, a pipe portion, an outlet, and a plunger. The pipe portion extends from the reservoir portion through the center of the dielectric resonator to the outlet. The reservoir portion slidably receives the plunger at an end opposite to the outlet such that pressing the plunger inwardly toward the outlet causes the liquid sample to flow from the reservoir portion, through the pipe portion, and out the outlet.

According to another aspect of the invention, there is provided a sensor system including a source of input radiation having a frequency between about 30 GHz and 3 THz, a whispering gallery mode resonator module coupled to the source for receiving the input radiation, and a detector coupled to the whispering gallery mode resonator module. The whispering gallery mode resonator module is configured to support at least one whispering gallery mode for the input radiation, and output a transmission response having a resonance characteristic related to the at least one whispering gallery mode. The detector is configured to detect the transmission response.

In some embodiments, the system may include a controller in communication with the detector for receiving the transmission response and extracting the resonance characteristic. The whispering gallery mode resonator module may be configured to receive a sample, having a property of interest, that supports or interacts with the at least one whispering gallery mode, and output a sample transmission response having a sample resonance characteristic related to the at least one whispering gallery mode for the sample. The controller may be configured to quantify the property of interest for the sample based on the sample resonance characteristic.

In some examples, the whispering gallery mode resonator module may be configured to receive a reference sample that supports or interacts with the at least one whispering gallery mode, and output a reference transmission response having a reference resonance characteristic related to the at least one whispering gallery mode for the reference sample. The controller may be configured to compare the sample resonance characteristic and the reference resonance characteristic so as to quantify the property of interest for the sample.

In some examples, the system may include a database in communication with the controller for storing at least one reference resonance characteristic for at least one reference sample. The controller may be configured to compare the sample resonance characteristic and the at least one reference resonance characteristic so as to quantify the property of interest for the sample.

According to another aspect of the invention, there is provided a method of analyzing a sample having a property of interest. The method includes receiving input radiation having a frequency between about 30 GHz and 3 THz, coupling the input radiation to a whispering gallery mode resonator module that is configured to support at least one whispering gallery mode for the input radiation, receiving the sample within the whispering gallery mode resonator module so as to support or interact with the at least one whispering gallery mode for the input radiation, and measuring a sample resonance characteristic related to the at least one whispering gallery mode for the sample.

The method may include quantifying the property of interest for the sample based on the sample resonance characteristic.

In some examples, the method may include providing at least one reference resonance characteristic for at least one reference sample, and comparing the sample resonance characteristic to the reference resonance characteristic so as to quantify the property of interest.

In some examples, the method may include receiving a reference sample within the whispering gallery mode resonator module so as to support or interact with the at least one whispering gallery mode for the input radiation, measuring a reference resonance characteristic related to the at least one whispering gallery mode for the reference sample, and comparing the sample resonance characteristic to the reference resonance characteristic so as to quantify the property of interest. The method may also include storing the reference resonance characteristic and information about the reference sample in a database.

In some embodiments, the method may include storing the sample resonance characteristic and information about the sample in a database.

In some embodiments, the whispering gallery mode resonator module may include a disk shaped dielectric resonator having a circumferential edge. The dielectric resonator being configured to support the at least one whispering gallery mode for the input radiation. In some examples, the method may include positioning the sample proximal to the circumferential edge of the dielectric resonator so as to interact with the at least one whispering gallery mode for the input radiation. In some examples, the method may include positioning the sample proximal to the center of the dielectric resonator so as to interact with the at least one whispering gallery mode for the input radiation.

According to another aspect of the invention, there is provided a whispering gallery mode resonator module including an input coupler configured to receive input radiation having a frequency of between about 30 GHz and 3 THz, a dielectric waveguide having an input end coupled to the input coupler for receiving the input radiation and an output end opposite the input end, and an output coupler coupled to the output end of the dielectric waveguide. The dielectric waveguide is sized, shaped and positioned to propagate the input radiation from the input end to the output end. The whispering gallery mode resonator module is configured to receive a sample between the input end and the output end of the dielectric waveguide and offset from the dielectric waveguide. The sample acts as a dielectric resonator. The sample is sized and shaped so as to cooperate with the dielectric waveguide to support at least one whispering gallery mode for the input radiation. The output coupler is configured to output a transmission response having a resonance characteristic related to the at least one whispering gallery mode. In some embodiments, the sample may be a pharmaceutical tablet.

Other aspects and features of the invention will become apparent, to those ordinarily skilled in the art, upon review of the following description of some exemplary embodiments.

### BRIEF DESCRIPTION OF THE DRAWINGS

Various embodiments will now be described, by way of example only, with reference to the following drawings, in which:

FIG. 1 is a schematic diagram of a sensor system made in accordance with a first embodiment;

FIG. 2 is a perspective view of the whispering gallery mode resonator module of the sensor system of FIG. 1;

FIG. 3 is a diagram depicting the strength of the electromagnetic energy at a critical coupling condition for a whispering gallery mode, at various points along the waveguide and around the dielectric resonator;

FIG. 4 is a graph depicting the simulated transmission and reflection response for the same structure as shown in FIG. 3;

FIG. 5A is a graph showing the measured frequency response of the sensor system adjusted for critical coupling at the second mode;

FIG. 5B is a graph showing the measured frequency response of the sensor system adjusted for critical coupling at the third mode; FIG. 5C is a graph showing the measured frequency response of the sensor system adjusted for critical coupling at the fourth mode;

FIG. 6 is a graph showing a simulated transmission response for a critical coupling condition, and two transmission responses for perturbations from the critical coupling condition;

FIG. 7 is a graph showing a simulated transmission response of the whispering gallery mode resonator module of FIG. 2, and the corresponding electromagnetic field strength at two different times;

FIG. 8 is a graph showing the transmission responses of the subject sensor system with water droplet samples applied to the center and the border of the dielectric resonator;

FIG. 9 is a graph showing the transmission responses of the subject sensor system to various different sample liquids;

FIG. 10 is a graph showing the transmission responses of the subject sensor system for 0.5-μL droplets of ethanol-water mixtures with different concentration ratios;

FIG. 11 is a perspective view of a whispering gallery mode resonator module, made in accordance with a second embodiment;

FIG. 12 is a schematic diagram of a dielectric resonator for use with measuring liquid properties made in accordance with another embodiment;

FIG. 13 is a schematic diagram of a dielectric resonator for use with measuring liquid properties made in accordance with another embodiment; and

FIG. 14 is a flow chart showing a method of analyzing a sample having a property of interest according to another embodiment.

### DETAILED DESCRIPTION

The present inventors have recognized that millimeter-wave (ranging from 30 gigahertz to 300 gigahertz) and terahertz (ranging from 300 gigahertz to 3 terahertz) biosensors are particularly promising devices for classification, quantification, monitoring, and sensing of samples, such as health care products, biologics, and tissue samples.

Inter-molecular transitional and rotational resonances associated with the crystalline structures of the biological and pharmaceutical components such as DNAs, RNAs, proteins, benzoic acids, carbamazepine, and tartaric acids, composed of macromolecules, tend to fall in the terahertz and millimeter-wave frequency range. This is a unique and inherent property of terahertz and millimeter waves, which makes them superior to lower frequency ranges such as the microwave, and higher frequency ranges such as the infrared and optical radiations (with sub-micrometer wavelength beyond the terahertz range) for certain material sensing and spectroscopy applications.

The inventors have further determined that optimally shaped resonant structures supporting particular resonant modes, such as the whispering gallery modes in terahertz and millimeter-wave frequency ranges, show high sensitivities and detection capabilities for a wide range of complex biological nano-structures, chemical/bio-chemical compounds, and pharmaceutical materials in various configurations. The underlying principle is strong field confinement in such structures, which significantly enhances the field-matter interactions.

The inventors have discovered that whispering gallery resonator sensors made in accordance with the embodiments described herein can be operated in the terahertz and millimeter-wave frequency range, where many pharmaceutical and biological materials and components have distinct absorption fingerprints. The subject terahertz and millimeter wave whispering gallery sensors can be used to create compact and low-cost sample sensor devices for quantifying a property of interest, such as identification and classification of drug samples from different companies, sensing their moisture content, and quantifying materials in micro- and pico-litre volume of solutions.

The whispering gallery resonator sensors at terahertz frequencies are smaller in size compared to their millimeter-wave counterparts, which makes it possible to sense minute amount of sample with higher accuracy and possibly in-vivo applications.

Dielectric Resonators (DR's) with high Q-factors are good candidates for sensor devices with high sensitivity. At terahertz and millimeter-wave frequencies, the higher order modes, i.e. whispering gallery modes (WGM's) of cylindrical dielectric resonators tend to be more attractive, since the size of the resonator becomes impractically small at conventional TE, TM or hybrid mode regimes. Dielectric resonators acting on whispering gallery modes at terahertz and millimeter-wave frequencies tend to have many advantages. For example, their dimensions are relatively large, even when used with terahertz and millimeter-wave frequencies, and are therefore less sensitive to fabrication tolerances or manufacturing defects. Their quality factor is also generally very large, and the unloaded quality factor of whispering gallery mode is normally only limited by the value of the material loss tangent while the radiation loss is negligible.

Whispering gallery mode (WGMₙₘₗ) resonances can be described as traveling-wave modes propagating around the center of a circular resonator, with repeated total reflection from the outer curved surface, and the phase change of integer multiples of 2π per rotation. WGM resonances are attractive for sensing in millimeter-wave and terahertz range due to high sensitivity and selectivity resulting from the fact that they exhibit a high Q factor as the unloaded Q factor is generally only limited by the loss tangent of the resonator material. Moreover, the open structure of a resonator, unlike the metallic cavity, makes it very convenient to place and remove a sample at predetermined locations on or adjacent to the resonator.

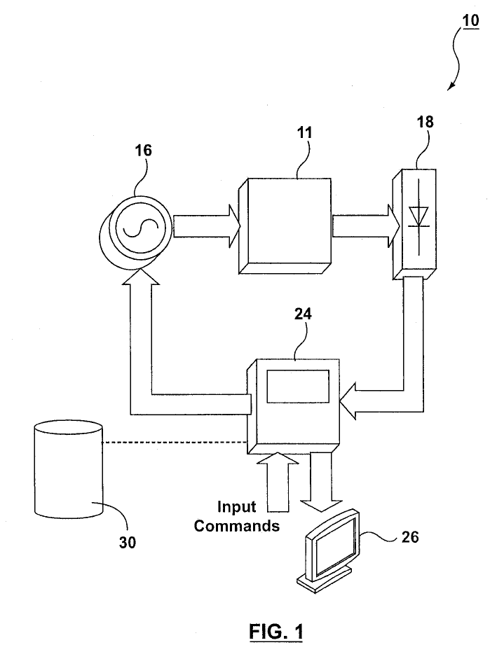

Referring now to FIG. 1, illustrated therein is a sensor system 10 made in accordance with a first embodiment. The sensor system 10 comprises a whispering gallery mode resonator module 11, a source 16 for providing terahertz and/or millimeter-wave input radiation (e.g. input radiation having a frequency between about 30 GHz and 3 THz) to the whispering gallery mode resonator module 11, a detector 18 for detecting the output terahertz and/or millimeter-wave radiation from the whispering gallery mode resonator module 11 in the form of a transmission response, and a controller 24 for receiving and processing the detected output terahertz and/or millimeter-wave radiation. The controller 24 may also be configured to receive user input and to adjust the source 16 to change the frequency of the input radiation. The sensor system 10 may further comprise a display 26 for displaying the processed output terahertz and/or millimeter-wave radiation.

The source 16 may be made of high frequency solid-state components to generate millimeter-wave or terahertz input radiation to feed the whispering gallery mode resonator module 11. The frequency of the source 16 can be adjusted within the range of interest either electronically, e.g. by a varactor diode or mechanically, e.g. by a micrometer knob.

The source 16 is generally configured to provide input radiation having a frequency of between about 30 GHz and 3 THz. In some embodiments, the input radiation may have a frequency of between about 500 GHz and 3 THz. In some embodiments, the source 16 may be a Gunn diode or another suitable source of terahertz or millimeter-wave radiation.

The whispering gallery mode resonator module 11 is coupled to the source 16 for receiving the input radiation. The whispering gallery mode resonator module 11 is configured to support at least one whispering gallery mode for the input radiation, and to output a transmission response having a resonance characteristic related to the whispering gallery mode. The whispering gallery mode resonator module 11 will be described in further detail below.

The detector 18 converts the millimeter or terahertz waves coming from the whispering gallery mode resonator module 11, in the form of a transmission response, into an electronic signal used for extracting the sensing information. In some embodiments, the detector 18 may comprise a Schottky diode detector, an appropriate power meter, or another suitable detector.

The controller 24 is generally in communication with the detector 18 so as to receive the transmission response and extract the resonance characteristic. The controller 24 may contain electronic circuitry for performing various tasks such as controlling the source 16, calibrating the sensor system 10, extracting sensing information from the detector 18, and communicating with the user by receiving the input commands and sending appropriate data to the display 26.

In some embodiments, the source 16 and the detector 18 may be designed to target a wide frequency sweep, rather than specific small frequency ranges. In that case, commercial signal generators and network analyzers may be used as the source 16 and detector 18.

The whispering gallery mode resonator module 11 is generally configured to receive a sample having a property of interest. The sample tends interact with the whispering gallery modes supported by the whispering gallery mode resonator module 11 as will be described in further detail below. When a sample is received, the whispering gallery mode resonator module 11 may output a sample transmission response having a sample resonance characteristic related to the whispering gallery mode for the sample. The controller 24 may then extract the sample resonance characteristic from the sample transmission response, and quantify the property of interest for the sample based on the sample resonance characteristic. In other words, the whispering gallery mode resonator module 11 may act as a transducer to convert a sensing property of interest for a sample into a measurable resonance characteristic such as resonance frequency and/or resonance quality factor.

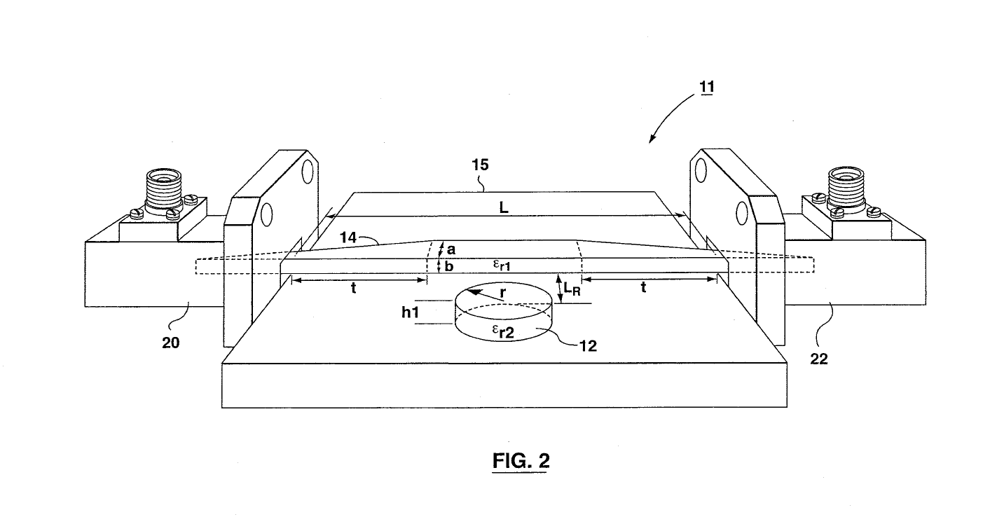

Referring now to FIG. 2, the whispering gallery mode resonator module 11 may include a dielectric resonator 12 configured to support the whispering gallery modes for the input radiation, which are generally terahertz and/or millimeter-wave electromagnetic waves. The whispering gallery mode resonator module 11 may also include a waveguide 14 configured to couple the input radiation into the dielectric resonator 12, an input coupler 20 for coupling terahertz and/or millimeter-wave input radiation from the source 16 to the waveguide 14, and an output coupler 22 for coupling the output terahertz and/or millimeter-wave radiation, in the form of a transmission response, from the waveguide 14 to the detector 18.

The input coupler 20 is generally configured to receive input radiation having a frequency of between about 30 GHz and 3 THz. For example, the input coupler 20 may receive input radiation from the source 16. In some embodiments, the input radiation may have a frequency of between about 500 GHz and 3 THz.

The dielectric waveguide 14 has an input end coupled to the input coupler 20 for receiving the input radiation, and an output end opposite the input end. The dielectric waveguide 14 is generally sized and shaped to propagate the input radiation from the input end to the output end. The output end is coupled to the output coupler 22 for outputting the transmission response to the detector 18.

In some embodiments, the dielectric waveguide 14 may be optimized for evanescently coupling the input radiation into the dielectric resonator 12.

The dielectric resonator 12 is generally positioned between the input end and the output end of the dielectric waveguide 14 and offset from the dielectric waveguide 14. The dielectric resonator 12 is sized, shaped and positioned to cooperate with the dielectric waveguide 14 so as to support at least one whispering gallery mode for the input radiation. In some embodiments, the dielectric resonator 12 may support at least five modes for the input radiation. Providing more whispering gallery modes may provide better measurements as will be described below.

In some embodiments, the dielectric resonator 12 may be in the shape of a disk and can be made of high-resistive silicon. The top surface of the dielectric resonator 12 may be shaped for receiving the sample where the whispering gallery modes interact with the sample. Generally, the dielectric resonator 12 is placed in close proximity to the dielectric waveguide 14, while maintaining an offset distance L_{R} therefrom.

In some embodiments, the waveguide 14 can be a dielectric waveguide made of alumina as generally shown in FIG. 2.

In some embodiments, the dielectric resonator 12 can be made of high-resistive silicon. The dielectric waveguide 14 and the dielectric resonator 12 may be in other suitable shapes and made of any known, suitable materials.

In the illustrated embodiment, the dielectric waveguide 14 has a width of a, height of b, and length of L. The dielectric resonator 12 is shown as a disc having a radius of r, a height of h, and a surface shaped to receive the sample. The radius r is generally on the order of millimeters. For example, the radius may be between about 0.5 and 10 millimeters. In the illustrated embodiment, the radius is about 4.75 millimeters.

The dielectric resonator 12 is also located an offset distance of L_{R} from the dielectric waveguide 14. The offset distance may be on the order of millimeters. For example, the offset distance may be between about 0.05 and 3 millimeters. In the illustrated embodiment, the offset distance is approximately 0.9 millimeters.

The whispering gallery mode resonator module 11 may also include a support plate 15, which may be made of aluminum or another suitable material. Both the dielectric waveguide 14 and dielectric resonator 12 may be placed on the support plate 15 to create a dielectric image waveguide. The power coupling into and out of the dielectric waveguide 14 may be realized by using the input coupler 20 and the output coupler 22. Couplers 20 and 22 may be metallic rectangular waveguide adaptors such as the 2.9 mm coaxial to WR-28 waveguide adaptors.

In dielectric waveguide structures, most of the energy of the signal is confined inside the dielectric region, while the tail of the guided field is accessible outside the physical waveguide, which makes it suitable for power coupling to the dielectric resonator. The extension of the field tail can be controlled by changing the width of the dielectric waveguide, parameter a as shown in FIG. 2. A smaller width a for the dielectric waveguide 14 generally results in a longer tail for the field. Therefore, in this case, the coupling between dielectric resonator 12 and dielectric waveguide 14 would be less sensitive to the distance L_{R}.

The whispering gallery modes in a cylindrical dielectric resonator 12 are azimuthally traveling waves in the plane of the circular cross section. Most of the modal energy is confined in a small region around the circumference of the dielectric resonator 12 and an evanescent tail is extended outside the dielectric resonator 12. Therefore, these modes can be easily excited when the dielectric resonator 12 is placed relatively close to the dielectric waveguide 14, for example, by using an offset distance L_{R} on the range of millimeters and submillimeters.

It is generally possible to design a dielectric resonator 12 with several higher order whispering gallery modes with different resonance frequencies in a given frequency band. For each whispering gallery mode there is a critical coupling condition under which the corresponding mode will have a dominant transmission response with higher Q-factor compared to the other modes. The dominant mode can be selected by adjusting the coupling between dielectric resonator 12 and the dielectric waveguide 14, for example, by adjusting the offset distance L_{R} so as to provide a critical coupling condition for a given frequency of the input radiation.

This characteristic enables one to set the dominant mode near the frequency at which the sample, e.g. a biological specimen, has an absorption signature. When the dielectric resonator 12 is loaded by a thin layer or a droplet or other forms of the sample placed on top or near the dielectric resonator 12, the sample interacts with the whispering gallery mode and there is a change in the resonance characteristic, such as the Q-factor and resonance frequency, of the dominant mode due to the presence of the sample. The change in the resonance characteristic can be monitored by the detector 18 and the controller 24 to extract identity information about the bio-sample. Variation in the resonance characteristics, if calibrated properly, can be used to quantify the sample's property of interest. The sampling procedure and results will be discussed in greater detail below.

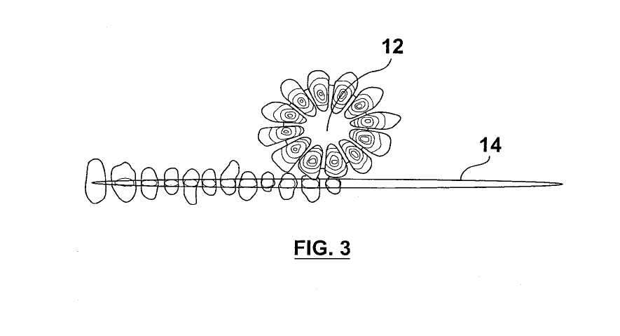

Referring now to FIG. 3, illustrated therein is a diagram showing the field distribution for a resonance mode under near critical coupling condition obtained from full-wave numerical simulation of one embodiment. The dielectric waveguide 14 is alumina with a=1 mm and b=2.1 mm. The dielectric resonator 12 is a disc made from silicon with r=4.75 mm and h=1 mm, and L_{R} was selected to be 0.9 mm to obtain near critical coupling at 31.53 GHz. It can be seen from FIG. 3 that the input power is coupled to the dielectric resonator 12 to excite and support a whispering gallery mode traveling wave around the resonator 12 in the counter clockwise direction, and only a very small amount of power transmitted to the output end of the waveguide 14 (i.e. the second port on the right hand side).

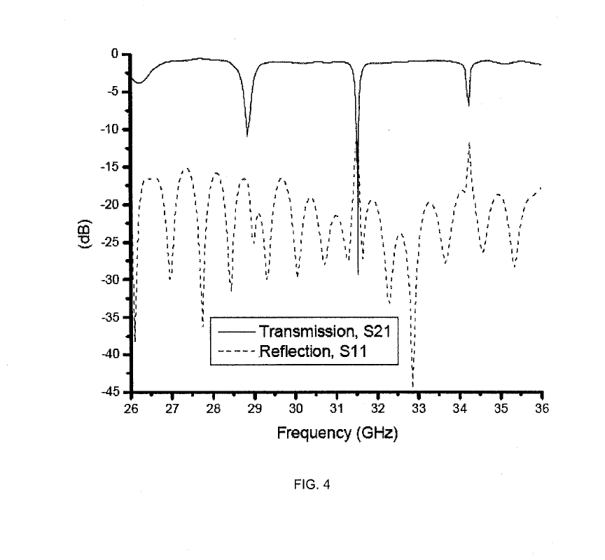

FIG. 4 shows the simulated transmission and reflection for the same structure as shown in FIG. 3. Four resonances are observed in the 26-36 GHz frequency band. The mode with resonance frequency of 31.53 GHz has a deeper and narrower transmission response compared to the other modes. This observation shows that near critical coupling condition has been provided for this mode. It is notable that the reflection at the resonance frequencies is generally less than about −10 dB at the resonance frequencies, which generally signifies the transmission response is only marginally affected by reflection.

It is possible to provide near critical coupling for any of the modes appearing in the frequency band so that the frequency associated with that mode will have a pronounced transmission response. This can be done by changing the offset distance L_{R} between the dielectric resonator 12 and the dielectric waveguide 14.

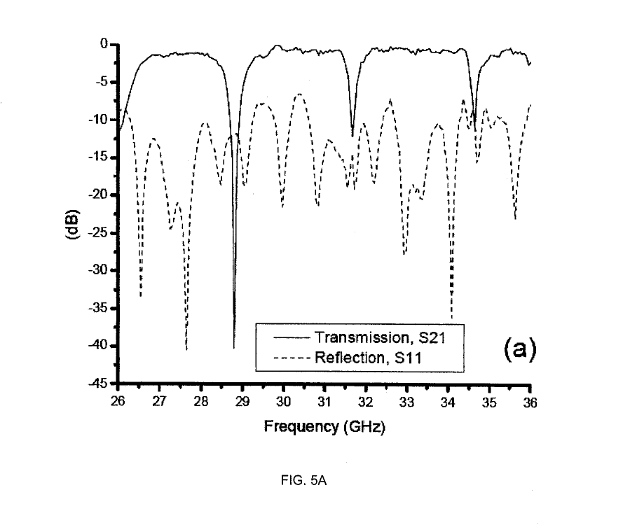

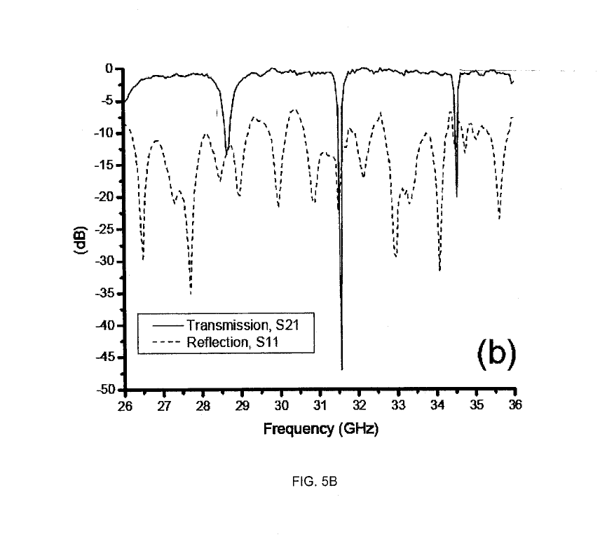

Referring now to FIGS. 5A, 5B and 5C, illustrated therein are the measured transmission response for an embodiment of the subject sensor system at critical coupling for various modes. The results are obtained using the sensor system 10 of FIG. 1, where the dielectric waveguide 14 is made of alumina with ∈ᵣ=9.8, tan δ=0.0001 and L=35 mm, and is placed on the support plate 15. The waveguide 14 is also tapered at both ends as shown in FIG. 2 to decrease the reflection, and is excited through an input coupler 20 such as a rectangular waveguide adaptor or a coaxial to WR-28 adaptor. The waveguide may be linearly tapered, for example with a tapered length of 10 mm.

The cylindrical dielectric disk resonator 12 is made from high resistive silicon with ∈ᵣ=11.2, tan δ=0.0001 with the same dimensions as used for obtaining the simulation result shown in FIG. 4. As shown in the simulation results of FIG. 4, the measured frequency response for the dielectric resonator 12 includes four resonance modes at 26.00 GHz, 28.81 GHz, 31.66 GHz, and 34.63 GHz respectively.

The offset distance L_{R} was adjusted to get near critical coupling for the second mode in FIG. 5a (i.e. at 28.81 GHz), the third mode in FIG. 5b (i.e. at 31.66 GHz), and the fourth mode in FIG. 5c (i.e. at 34.63 GHz). It is notable that in each graph the Q-factor of the near-critical coupling mode is the highest, which corresponds to the simulation results.

Alternatively, to study the power exchange between the dielectric waveguide 14 and the dielectric resonator 12 and the critical coupling condition, a generic coupling model can be considered. Assuming that a unidirectional mode of the resonator is excited, and the coupling is lossless, in this generic model, the power transmission coefficient, T, of the waveguide coupled to the resonator can be expressed as:

$$T = \frac{1 + {α}^{2} - {κ}^{2} - 2 α \sqrt{1 - {κ}^{2}} cos θ}{1 + {α}^{2} - {( α κ )}^{2} - 2 α \sqrt{1 - {κ}^{2}} cos θ} \qquad ( Equation 1 )$$

where 0<α<1 is the loss factor of the resonator (α=1 represents a lossless resonator), κ is the coupling coefficient magnitude, and θ is the phase shift per rotation inside the resonator. At the resonance condition, θ=2πm, and when α=√(1−K²) is satisfied, the transmitted power vanishes according to Equation 1 resulting in T=0. Under this condition, which is known as critical coupling, the transmission response is extremely sensitive to any perturbation occurring in the value of α, κ, or θ resulting from placing a sample into the sensitive area on top or in close proximity to the surface of the dielectric disk resonator 12.

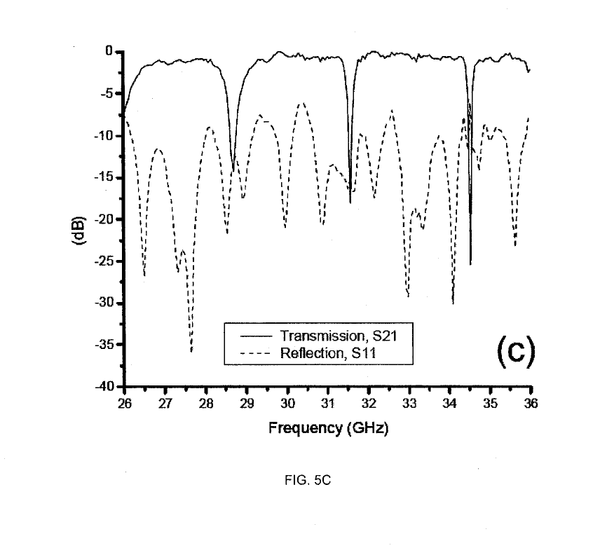

Referring to FIG. 6, illustrated therein is a graph showing a simulated transmission response in accordance with equation 1 for a resonance at the critical coupling condition, and two of its variations obtained by 0.01% and 0.05% perturbation in α, and 0.036° increase in θ. The resonance line width and the frequency shift for the perturbed mode are attributed to the dielectric loss and dielectric constant of the sample, respectively. This model predicts that a sample with higher dielectric loss produces wider line width and shallower dip in the transmission response for a given resonance mode, as shown in FIG. 6. Also, higher dielectric constant for the sample results in a larger frequency shift for the transmission response.

By developing further theoretical modeling and using the subject sensor system as a measurement tool, it may be possible to extract the absolute value of the dielectric parameters for the sample. However, in a majority of sensing applications, obtaining the absolute values is not important; rather determining the relative value of these parameters with respect to a reference material or other samples is of more interest.

In designing the subject sensor system, for some form of the sample (such as a liquid droplet), it is desirable to make the coupling between the dielectric resonator 12 and the dielectric waveguide 14 highly directional. Otherwise, a standing wave can be produced inside the dielectric resonator 12 which makes the transmission response dependent on the position of the sample with respect to the mode pattern (e.g. if the drop is located on an anti-node of the standing wave, it has the most interaction with the field whereas the least interaction occurs at the nodes).

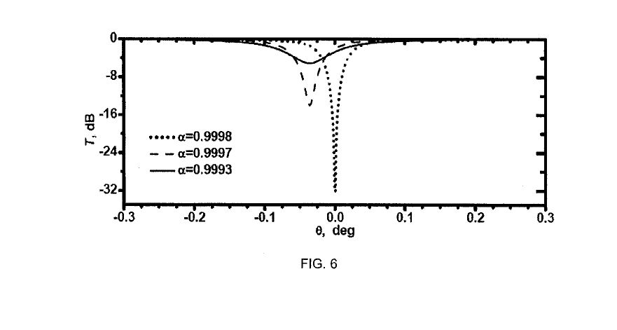

Referring now to FIG. 7, illustrated therein is a graph showing the simulated transmission response of the whispering gallery mode resonator module of FIG. 2, with design parameters r=5.0 mm, h=1.0 mm, ∈ᵣ=14, and tan δ=1×10⁻⁴ for the dielectric resonator 12, and a=1.0 mm, b=2.1 mm, L=35 mm, ∈ᵣ=9.8, and tan δ=1×10⁻⁴ for the dielectric waveguide 14. As shown in FIG. 7, the insets illustrate two snapshots of the traveling-wave field distribution of a mode at different times for the first resonance mode at 29.6 GHz.

The WGM of dielectric resonators can be classified as WGE and WGH. In a WGE mode, the electric field is essentially transversal, while in a WGH mode, the electric field is essentially axial. The field shown in the left inset has 72° phase lead. Comparing the field patterns in the insets reveals the movement of the peaks and nulls of the traveling field over time (phase). The field is mainly confined near the circumference of the disk where the most sensitive sensing area is formed. The first resonance mode is under near critical coupling condition, and as shown in the insets, minimal power is coupled to the output coupler 22.

The inventors have determined that the critical coupling condition can be achieved for any of the resonances occurring in the frequency range of interest by adjusting the offset distance L_{R} between the dielectric resonator 12 and dielectric waveguide 14. This enables one to easily choose any desired resonance mode to perform high sensitivity sensing.

For sensing a sample having a property of interest, the transmission response of a dielectric waveguide coupled to the dielectric resonator is measured as a sample transmission response. From the measured sample transmission response, the sample resonance characteristics, i.e. resonance frequency and resonance quality factor, are extracted and analyzed by the controller 24. The controller 24 may then quantify a property of interest for the sample based on the sample resonance characteristic.

In some embodiments, the controller 24 may quantify the property of interest by using reference samples. For example, the whispering gallery mode resonator module 11 may be configured to receive a reference sample that interacts with the whispering gallery mode so as to output a reference transmission response having a reference resonance characteristic related to the whispering gallery mode for the reference sample. The controller 24 may then compare the sample resonance characteristic and the reference resonance characteristics so as to quantify the property of interest for the sample.

Referring to FIG. 1, in some embodiments, the sensor system may also include a database 30 in communication with the controller 24. The database 30 may be generally configured to store one or more reference characteristics for one or more reference samples. The controller 24 may then communicate with the database to compare the sample resonance characteristic and the reference resonance characteristics so as to quantify the property of interest for the sample. The database 30 may include pre-existing data for sample characterization, or the database 30 may receive data by analyzing reference samples using the sensor system 10.

At least four configurations can be assumed for sensing the sample, namely: (1) the stagnant sample can be placed on or near the dielectric resonator surface in the sensor system 10 shown in FIG. 1, (2) the sample can be placed on or near the dielectric resonator surface while undergoing natural or deliberate alterations of the physical/chemical properties of the sample due to environmental or other factors, (3) immersing a part of the sensor system in a medium which contains the sample, and (4) the dielectric resonator can be a suitably shaped sample itself, such as a pharmaceutical tablet, which will be discussed in further detail below.

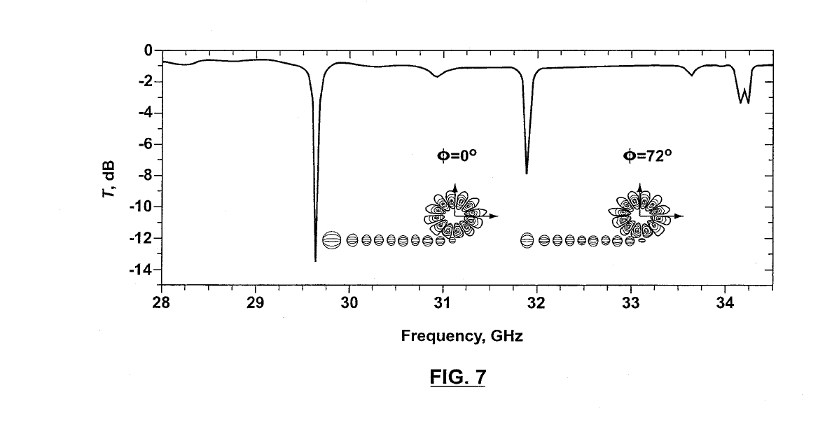

Referring to FIG. 8, illustrated therein is a graph showing the transmission responses of the sensor system 10 with water droplet samples applied to the center and the border (i.e. the circumferential edge) of the top surface of the dielectric resonator 12. A network analyzer is deployed to measure the transmission response of the sensor system 10 in the frequency range of interest. To improve repeatability of the measured response, a micro-injector installed on a customized translation stage is used to control the drop volume and the location where the drop is dispensed.

Generally, the smallest volume that could be dispensed by the available injector was 0.5 μL. The average diameter of the spot occupied by the 1 μL and 0.5 μL drop of water on the disk surface was around 2 mm and 1 mm, respectively. The ratio of the drop spot area to the resonator surface area with the confined electromagnetic field is calculated as 1.2 percent for the 0.5 μL drop.

As shown in FIG. 8, the measured transmission response when a 1 μL water droplet is placed near the border (i.e. the circumferential edge) of the disk is compared with the case where the water droplet is in the center area of the top surface of the disk dielectric resonator 12. Given the field distribution in FIG. 3, the border shows higher sensitivity compared to the center area due to higher field-sample interaction.

In the experiment, it was observed and realized by the inventors that when the location of the drop moves around the circumferential edge of the dielectric resonator 12, the transmission response does not change noticeably unless the drop is close to the coupling region near the dielectric waveguide 14. This tends to confirm that in practice the excited mode is a traveling wave and not a standing wave.

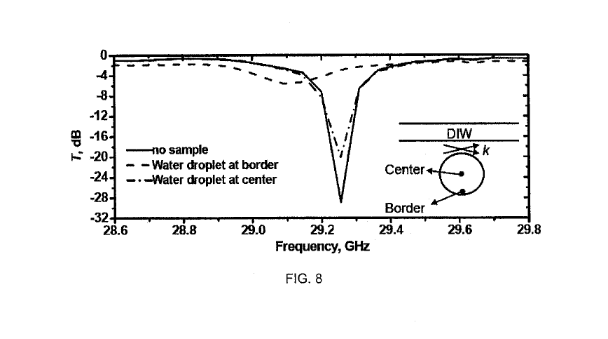

Referring now to FIG. 9, illustrated therein is a graph showing the transmission responses of the sensor system 10 for water, propanol, methanol and no sample. In this experiment, the relative resonance line width and the frequency shift of the transmission response are consistent with the relative values of the dielectric loss and the dielectric constant of the corresponding liquid (e.g. water has the highest value for the dielectric loss and the dielectric constant among the tested liquids and, as shown in FIG. 9, it produces a transmission response with the widest line width and the largest frequency shift in comparison to the transmission response with no sample).

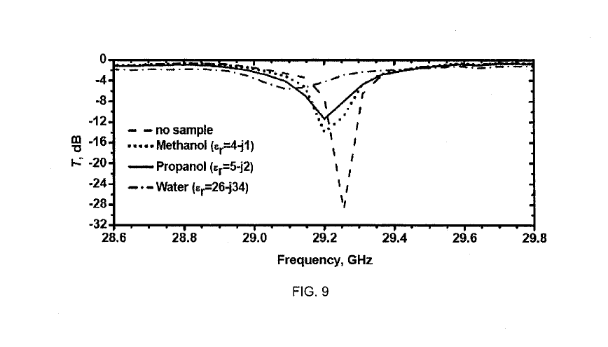

Referring now to FIG. 10, shown therein is a graph showing the transmission responses of the sensor system 10 for 0.5-μL droplets of ethanol-water mixtures with different concentration ratios, namely 100% ethanol, 85% ethanol, 83% ethanol, and 50% ethanol. As shown in FIG. 10, a concentration difference as small as 2% (between 83% and 85% ethanol) can be easily resolved or detected using this sensor system and method. One benefit of the performed experiments is the repeatability of the measured responses, which tends to illustrate the robustness of the sensing system and method.

These experiments tend to show that, under a critical coupling condition, a small perturbation in the resonance mode tends to manifest itself in a noticeable change in the transmission response. For example, placing a sample adjacent to the dielectric resonator 12 so as to interact with the whispering gallery mode tends to provide a change in the transmission response. This change depends on the size and the location of the sample, as well as its dielectric properties.

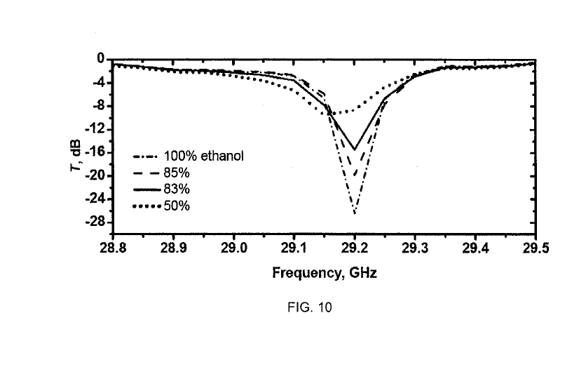

Referring now to FIG. 11, illustrated therein a whispering gallery mode resonator module 110 made in accordance with another exemplary embodiment. The whispering gallery mode resonator 110 is similar to the whispering gallery mode resonator 10 of FIG. 2, except that the whispering gallery mode resonator 110 is configured to receive a sample 13 shaped to act as a dielectric resonator that supports the whispering gallery modes. In contrast, the whispering gallery mode resonator module 11 received a sample that interacts with the whispering gallery modes, as opposed to supporting them.

Accordingly, the sensor system 10 may include whispering gallery mode resonator modules configured to receive samples that support, or interact with, the whispering gallery modes, for example the whispering gallery mode resonator modules 11 or 110 respectively.

When the whispering gallery mode resonator module 110 is incorporated into the sensor system 10, the resonator module 110 exhibits behavior under critical coupling conditions that is similar to that of the whispering gallery resonator module 11. As noted above, for each resonance mode, there is a critical coupling condition under which the corresponding mode will have a pronounced transmission response with higher Q-factor for a resonance frequency compared to the other existing resonance modes.

At the critical coupling condition, the majority of the input power is coupled to the sample/dielectric resonator 13 and trapped inside. Minimal power is transmitted through the output end of the waveguide 14 or reflected back to the input end of the waveguide 14. This is similar to the whispering gallery mode resonator module 11 when under a critical coupling condition for a resonance mode.

Both whispering gallery mode resonator modules 11 and 110 can be used by sensor system 10 as a high sensitivity detection and/or monitoring device. For example, the sensor system 10 can be used to classify a large number of samples based on the differences in their electromagnetic parameters such as dielectric constant, magnetic permeability, and electromagnetic loss and geometrical characteristics such as shape, and size. Applications of this sensor include, but are not limited to, drug tablet quality control, analysis of (bio)chemicals in solution or liquid form, water pollutant monitoring, concentration detection in liquids or solutions, sample analysis in powder form, moisture content detection, and thin film analysis of solids or liquids. The system 10 can also be utilized in dielectric measurement/characterization of small-sized samples for scientific research.

In some embodiments, the sensor system 10 may be configured to measure properties of pharmaceuticals. For example, as shown in FIG. 11, the sample 13 may be a pharmaceutical tablet shaped to act as a dielectric resonator. Using the sample 13 as a dielectric resonator in this application is beneficial because it may be possible to quickly analyze the properties of the sample with minimal set up and configuration of the sensor system 10. The resonance characteristics for the sample 13 may then be compared to reference resonance characteristics so as to quantify a property of interest for the sample. The reference characteristics may be stored in a database along with information about the reference samples.

Using the sensor system 10 in this fashion can be particularly beneficial when checking to see whether a pharmaceutical tablet is a counterfeit product or an authorized product. In some instances, it is possible to analyze the pharmaceutical tablet while it is still in its packaging. Accordingly, the sensor system 10 may provide for non-destructive testing.

The use of a support plate 15 and a dielectric image waveguide may result in low cost, small size, lightweight, and ease of fabrication, in addition to its low loss characteristic in a wide band frequency operation when compared to other types of waveguide structures in the millimeter and terahertz wave range.

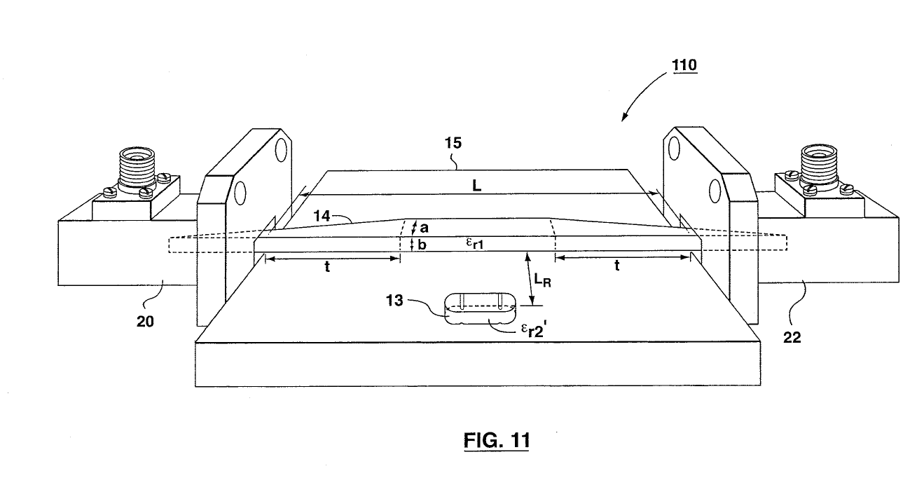

Referring now to FIG. 12, illustrated therein is a whispering gallery mode resonator module 211 made in accordance with another exemplary embodiment. The whispering gallery mode resonator module 211 is generally similar to the whispering gallery mode resonator module 11 except that it includes a dielectric resonator 212 in the shape of a ring having a central aperture, a container 240 for receiving a volume of liquid 242, and a valve 250.

As shown, a support plate 215 may support the dielectric resonator 212 and the container 240. The support plate 215 generally has an aperture aligned with the central aperture of the dielectric resonator 212.

The container 240 is generally made of a dielectric material. The container 240 has a reservoir portion 244 for receiving a liquid sample 242, a pipe portion 246, and an outlet 248. The pipe portion 244 extends from the reservoir portion 244, through the central aperture of the dielectric resonator 212, through the aperture in the support plate 215, and to the outlet 248. The reservoir portion 244 and the pipe portion 246 are generally cylindrical tubes. The reservoir portion 244 generally has a larger diameter than the pipe portion 246 such that a base portion 249 rests on top of the dielectric resonator 212. The reservoir portion 244 may also have an open top end for receiving an inflow of the liquid sample 242.

In some embodiments, the top end may be sealed to inhibit evaporation of the liquid sample 242.

The valve 250 is positioned between the dielectric resonator 212 and the outlet 248 of the container 240. The valve 250 is configured to selectively control flow of the liquid sample 242 from the reservoir portion 244, through the pipe portion 246, and out the outlet 248. With this configuration, the whispering gallery mode resonator module 211 can be used to analyze properties of the liquid sample 242 in a static state or in a dynamic state.

When the valve 250 is closed the liquid sample 242 may be generally still and tends not to move. In this case, the whispering gallery mode resonator module 211 can be used to analyze properties of the liquid sample 242 in the static state.

However, when the valve 250 is open, the liquid sample 242 tends to flow through the pipe portion 246 and the moving liquid sample 242 interacts with the whispering gallery modes of the dielectric resonator 212. In this case, the whispering gallery mode resonator module 211 can be used to analyze properties of the liquid sample 242 in the dynamic state.

In some embodiments, there may be an inflow of the liquid sample 242 into the top end of the reservoir portion 244 so as to replenish (in some cases continuously) the volume of the liquid sample 242 within the reservoir portion 244.

In some embodiments, the whispering gallery mode resonator module 211 may also include a spacer 252 positioned between the reservoir portion 244 of the container 240 and the dielectric resonator 212. The spacer 252 may be used to adjust the interaction between the whispering gallery mode and the liquid sample 242. Adjusting the interaction may allow greater accuracy in measurements. Generally, the thicker the spacer 252, the smaller the interaction.

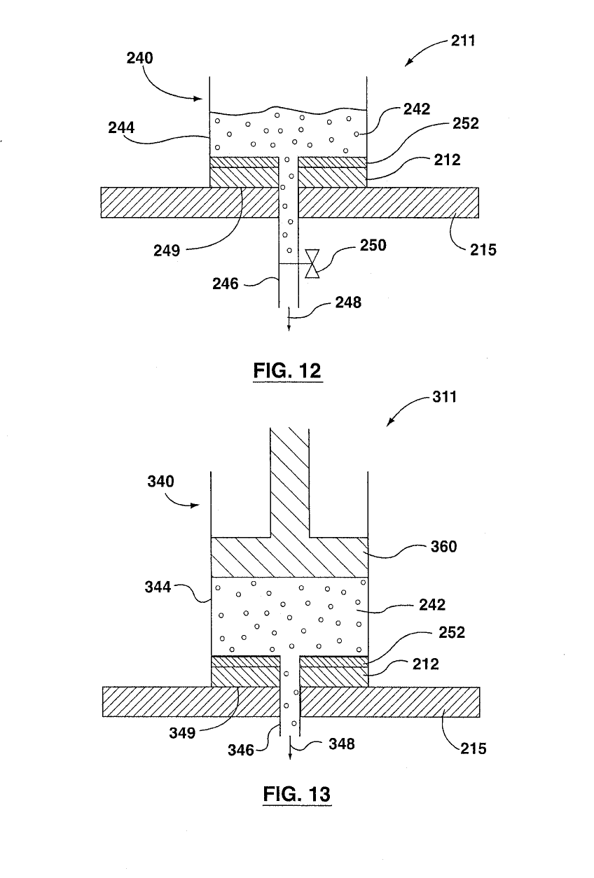

Referring now to FIG. 13, illustrated therein is a whispering gallery mode resonator module 311 made in accordance with another exemplary embodiment. The whispering gallery mode resonator module 311 is generally similar to the whispering gallery mode resonator module 211 except that it includes a syringe 340 instead of a container 240.

The syringe 340 is generally made of a dielectric material. The syringe 340 has a reservoir portion 344 for receiving a liquid sample 242, a pipe portion 346, an outlet 348, and a plunger 360. The pipe portion 344 extends from the reservoir portion 344, through the central aperture of the dielectric resonator 212, through the aperture in the support plate 215, and to the outlet 348. The reservoir portion 344 and the pipe portion 346 are generally cylindrical tubes. The reservoir portion 344 generally has a larger diameter than the pipe portion 346 such that a base portion 349 rests on top of the dielectric resonator 212 or the spacer 252.

The reservoir portion 344 slidably receives the plunger 360 at an end opposite to the outlet 348. Pressing the plunger 360 inwardly toward the outlet 348 plunger causes the liquid sample 242 to flow from the reservoir portion 344, through the pipe portion 346, and out the outlet 348.

As above, the whispering gallery mode resonator module 311 can generally be used to analyze properties of the liquid sample 242 in a static state or in a dynamic state.

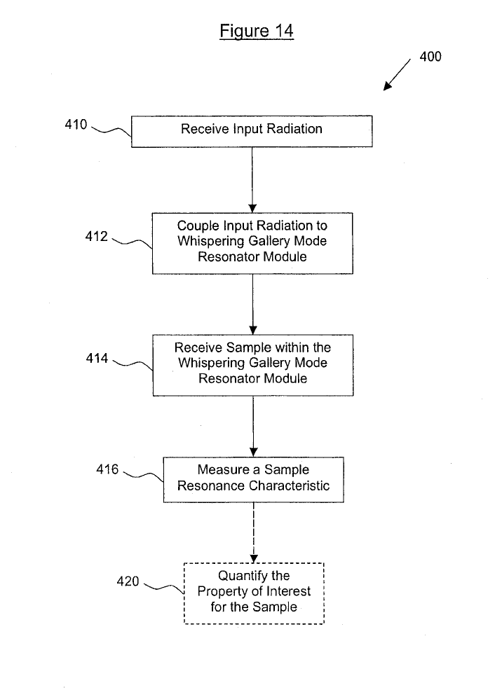

Referring now to FIG. 14, illustrated therein is a method 400 of analyzing a sample having a property of interest according to another embodiment.

Step 410 includes receiving input radiation having a terahertz or millimeter-wave frequency. For example, the input radiation may have a frequency between about 30 GHz and 3 THz. In some embodiments, the input radiation may have a frequency of between about 500 GHz and 3 THz.

Step 412 includes coupling the input radiation to a whispering gallery mode resonator module that is configured to support at least one whispering gallery mode for the input radiation.

Step 414 includes receiving the sample within the whispering gallery mode resonator module so as to support or interact with the at least one whispering gallery mode for the input radiation.

In some embodiments, the sample may be shaped to act as a dielectric resonator. In such embodiments, the sample would support the whispering gallery modes. In some embodiments, the sample may be a pharmaceutical tablet.

Step 416 includes measuring a sample resonance characteristic related to the at least one whispering gallery mode for the sample. In some embodiments, the method may include storing the sample resonance characteristic and information about the sample in a database.

The method 400 may also include step 420, which includes quantifying the property of interest for the sample based on the sample resonance characteristic. For example, step 420 may include providing at least one reference resonance characteristic for at least one reference sample, and comparing the sample resonance characteristic to the reference resonance characteristic so as to quantify the property of interest. The reference resonance characteristic for the reference sample may be provided from a database.

In another example, step 420 may include receiving a reference sample within the whispering gallery mode resonator module so as to support or interact with the at least one whispering gallery mode for the input radiation and then measuring a reference resonance characteristic related to the at least one whispering gallery mode for the reference sample. Step 420 continues by comparing the sample resonance characteristic to the reference resonance characteristic so as to quantify the property of interest. In some embodiments, the method 400 may include storing the reference resonance characteristic and information about the reference sample in a database.

In some embodiments the whispering gallery mode resonator may comprise a disk shaped dielectric resonator having a circumferential edge and a center. The dielectric resonator may be configured to support the at least one whispering gallery mode for the input radiation. In these embodiments, step 414 may include positioning the sample proximal to the circumferential edge of the dielectric resonator so as to interact with the at least one whispering gallery mode for the input radiation. Positioning the dielectric resonator at the circumferential edge tends to increase the interaction between the whispering gallery mode and the sample. This can be beneficial when the sample has a minimal effect on the resonance characteristics for the whispering gallery mode.

Alternatively, step 414 may include positioning the sample proximal to the center of the dielectric resonator so as to interact with the at least one whispering gallery mode for the input radiation. Positioning the dielectric resonator at the center tends to decrease the interaction between the whispering gallery mode and the sample. This can be beneficial when the sample has a strong effect on the resonance characteristics.

Positioning the sample on different parts of the dielectric resonator allows variable sensitivity. This may improve the accuracy of measurements when there are different samples having different properties.

While the above description includes a number of exemplary embodiments, many modifications, substitutions, changes and equivalents can be implemented by those of ordinary skill in the art without departing from the spirit and scope of the embodiments described herein.

1. A whispering gallery mode resonator module comprising:
(a) an input coupler configured to receive input radiation having a frequency of between about 30 GHz and 3 THz;
(b) a dielectric waveguide having an input end coupled to the input coupler for receiving the input radiation, and an output end opposite the input end, the dielectric waveguide being sized and shaped to propagate the input radiation from the input end to the output end;
(c) a dielectric resonator positioned between the input end and the output end of the dielectric waveguide and offset from the dielectric waveguide, the dielectric resonator sized, shaped and positioned so as to cooperate with the dielectric waveguide to support at least one whispering gallery mode for the input radiation; and
(d) an output coupler coupled to the output end of the dielectric waveguide for outputting a transmission response having a resonance characteristic related to the at least one whispering gallery mode.

2. The whispering gallery mode resonator module of claim 1, wherein the waveguide is optimized for evanescently coupling the input radiation into the dielectric resonator.

3. The whispering gallery mode resonator module of claim 1, wherein the dielectric resonator comprises a disk made of high-resistive silicon and having a surface shaped to receive a sample thereon.

4. The whispering gallery mode resonator module of claim 1, further comprising a support plate on which the dielectric waveguide and the dielectric resonator are placed.

5. The whispering gallery mode resonator module of claim 1, wherein the dielectric waveguide and the dielectric resonator are offset by an offset distance, and the offset distance is adjusted to provide a critical coupling condition for the input radiation.

6. The whispering gallery mode resonator module of claim 5, wherein the offset distance is between about 0.05 and 3 millimeters.

7. The whispering gallery mode resonator module of claim 1, wherein the input radiation has a frequency of between about 500 GHz and 3 THz.

8. The whispering gallery mode resonator module of claim 1, wherein the dielectric resonator is a sample that is shaped to act as a resonator.

9. The whispering gallery mode resonator module of claim 8, wherein the sample is a pharmaceutical tablet.

10. The whispering gallery mode resonator module of claim 1, wherein the dielectric resonator is configured to support at least five modes for the input radiation.

11. The whispering gallery mode resonator module of claim 1, wherein the dielectric resonator comprises a disk having a radius between about 0.5 and 10 millimeters.

12. The whispering gallery mode resonator module of claim 1, wherein the dielectric resonator comprises a ring having a central aperture, and the whispering gallery mode resonator module further comprises:
(a) a container having a reservoir portion for receiving a liquid sample, a pipe portion, and an outlet, and the pipe portion extends from the reservoir portion through the center of the dielectric resonator to the outlet; and
(b) a valve positioned between the dielectric resonator and the outlet, the valve is configured to selectively control flow of the liquid sample from the reservoir portion, through the pipe portion, and out the outlet.

13. The whispering gallery mode resonator module of claim 1, wherein the dielectric resonator comprises a ring having a central aperture, and the whispering gallery mode resonator module further comprises a syringe having a reservoir portion for receiving a liquid sample, a pipe portion, an outlet, and a plunger, wherein the pipe portion extends from the reservoir portion through the center of the dielectric resonator to the outlet, and the reservoir portion slidably receives the plunger at an end opposite to the outlet such that pressing the plunger inwardly toward the outlet causes the liquid sample to flow from the reservoir portion, through the pipe portion, and out the outlet.

14. A sensor system comprising:
(a) a source of input radiation having a frequency between about 30 GHz and 3 THz;
(b) a whispering gallery mode resonator module coupled to the source for receiving the input radiation, the whispering gallery mode resonator module configured to support at least one whispering gallery mode for the input radiation, and output a transmission response having a resonance characteristic related to the at least one whispering gallery mode; and
(c) a detector coupled to the whispering gallery mode resonator module for detecting the transmission response.

15. The system of claim 14, wherein the whispering gallery mode resonator module includes:
(a) a dielectric waveguide having an input end for receiving the input radiation, and an output end opposite the input end, the dielectric waveguide being sized and shaped to propagate the input radiation from the input end to the output end; and
(b) a dielectric resonator positioned between the input end and the output end of the dielectric waveguide and offset from the dielectric waveguide, the dielectric resonator sized, shaped and positioned so as to cooperate with the dielectric waveguide to support the at least one whispering gallery mode.

16. The system of claim 14, further comprising:
(a) a controller in communication with the detector for receiving the transmission response and extracting the resonance characteristic; and
(b) wherein the whispering gallery mode resonator module is configured to:
(i) receive a sample, having a property of interest, that supports or interacts with the at least one whispering gallery mode; and
(ii) output a sample transmission response having a sample resonance characteristic related to the at least one whispering gallery mode for the sample; and
(c) wherein the controller is configured to quantify the property of interest for the sample based on the sample resonance characteristic.

17. The system of claim 16, wherein the whispering gallery mode resonator module is configured to:
(a) receive a reference sample that supports or interacts with the at least one whispering gallery mode; and
(b) output a reference transmission response having a reference resonance characteristic related to the at least one whispering gallery mode for the reference sample;
(c) wherein the controller is configured to compare the sample resonance characteristic and the reference resonance characteristic so as to quantify the property of interest for the sample.

18. The system of claim 16, further comprising a database in communication with the controller for storing at least one reference resonance characteristic for at least one reference sample; and
wherein the controller is configured to compare the sample resonance characteristic and the at least one reference resonance characteristic so as to quantify the property of interest for the sample.

19. The system of claim 14, wherein the input radiation has a frequency between 500 GHz and 3 THz.

20. The system of claim 14, wherein the dielectric resonator is a sample that is shaped to act as a resonator.

21. The system of claim 20, wherein the sample is a pharmaceutical tablet.

22. A method of analyzing a sample having a property of interest, the method comprising:
receiving input radiation having a frequency between about 30 GHz and 3 THz;
coupling the input radiation to a whispering gallery mode resonator module that is configured to support at least one whispering gallery mode for the input radiation;
receiving the sample within the whispering gallery mode resonator module so as to support or interact with the at least one whispering gallery mode for the input radiation; and
measuring a sample resonance characteristic related to the at least one whispering gallery mode for the sample.

23. The method of claim 22, wherein the input radiation has a frequency of between about 500 GHz and 3 THz.

24. The method of claim 22, wherein the sample is shaped to act as a dielectric resonator.

25. The method of claim 24, wherein the sample is a pharmaceutical tablet.

26. The method of claim 22, further comprising quantifying the property of interest for the sample based on the sample resonance characteristic.

27. The method of claim 26, further comprising:
providing at least one reference resonance characteristic for at least one reference sample; and
comparing the sample resonance characteristic to the reference resonance characteristic so as to quantify the property of interest.

28. The method of claim 26, further comprising:
receiving a reference sample within the whispering gallery mode resonator module so as to support or interact with the at least one whispering gallery mode for the input radiation;
measuring a reference resonance characteristic related to the at least one whispering gallery mode for the reference sample; and
comparing the sample resonance characteristic to the reference resonance characteristic so as to quantify the property of interest.

29. The method of claim 28, further comprising storing the reference resonance characteristic and information about the reference sample in a database.

30. The method of claim 22, further comprising storing the sample resonance characteristic and information about the sample in a database.

31. The method of claim 22, wherein the whispering gallery mode resonator module comprises a disk shaped dielectric resonator having a circumferential edge, the dielectric resonator being configured to support the at least one whispering gallery mode for the input radiation, and wherein the method further comprises positioning the sample proximal to the circumferential edge of the dielectric resonator so as to interact with the at least one whispering gallery mode for the input radiation.

32. The method of claim 22, wherein the whispering gallery mode resonator module comprises a disk shaped dielectric resonator having a center, the dielectric resonator being configured to support the at least one whispering gallery mode for the input radiation, and wherein the method further comprises positioning the sample proximal to the center of the dielectric resonator so as to interact with the at least one whispering gallery mode for the input radiation.

33. A whispering gallery mode resonator module comprising:
(a) an input coupler configured to receive input radiation having a frequency of between about 30 GHz and 3 THz;
(b) a dielectric waveguide having an input end coupled to the input coupler for receiving the input radiation, and an output end opposite the input end, the dielectric waveguide being sized, shaped and positioned to propagate the input radiation from the input end to the output end; and
(c) an output coupler coupled to the output end of the dielectric waveguide;
(d) wherein the whispering gallery mode resonator module is configured to receive a sample that acts as a dielectric resonator between the input end and the output end of the dielectric waveguide and offset from the dielectric waveguide, the sample being sized and shaped so as to cooperate with the dielectric waveguide to support at least one whispering gallery mode for the input radiation; and
(e) wherein the output coupler is configured to output a transmission response having a resonance characteristic related to the at least one whispering gallery mode.

34. The whispering gallery mode resonator module of claim 33, further comprising a support plate on which the dielectric waveguide and the sample are placed.

35. The whispering gallery mode resonator module of claim 33, wherein the input radiation has a frequency of between about 500 GHz and 3 THz.

36. The whispering gallery mode resonator module of claim 33, wherein the sample is a pharmaceutical tablet.
